(19) United States
(12) Patent Application Publication
(10) Pub. No.: US 2024/0359559 A1
(43) Pub. Date: Oct. 31, 2024

(54) DISPLAY DEVICE AND CONTROL METHOD THEREFOR

(71) Applicant: HYUNDAI MOBIS CO., LTD., Seoul (KR)

(72) Inventors: Shin Yeong KIM, Yongin-si (KR); Young Woo CHO, Ansan-si (KR)

(73) Assignee: HYUNDAI MOBIS CO., LTD., Seoul (KR)

(21) Appl. No.: 18/630,383

(22) Filed: Apr. 9, 2024

(30) Foreign Application Priority Data
Apr. 27, 2023 (KR) 10-2023-0055532
May 2, 2023 (KR) 10-2023-0056887

(51) Int. Cl. B60K 35/81; B60K 35/22; B60K 35/55; B60R 11/00; B60R 11/02

(52) U.S. Cl. CPC B60K 35/81; B60K 35/223; B60K 35/55; B60R 11/0229; B60K 2360/1468; B60K 2360/148; B60K 2360/165; B60K 2360/1876; B60K 2360/48; B60K 2360/56; B60K 2360/771; B60R 2011/0028; B60R 2011/0057

(57) ABSTRACT

A transparent display apparatus disposed inside a vehicle is disclosed. the transparent display apparatus comprising: a transparent display panel configured to transmit light from a first surface to a second surface; a rotation part coupled to one end of the transparent display panel; an anchoring part fixed to a ceiling of the vehicle, wherein the anchoring part includes a motor coupled to at least a portion of the rotation part and configured to rotate the rotation part about a longitudinal direction of the rotation part; an interface unit mounted inside the transparent display panel and/or the vehicle to receive a user command; and a control unit operatively connected to the interface unit and the motor, and configured to perform control so that the transparent display panel is switched to a plurality of modes based on a user command received from the interface unit.

### CROSS-REFERENCE TO RELATED APPLICATIONS

The present application claims priority to and the benefit of Korean Patent Application No. 10-2023-0056887, filed on May 2, 2023, and Korean Patent Application No. 10-2023-0055532, filed on Apr. 27, 2023 the entire disclosure of which is incorporated herein by reference.

### TECHNICAL FIELD

The present disclosure relates to a display apparatus and a control method therefor.

### BACKGROUND

The content described in present section simply provides background information for the present disclosure and does not constitute related art.

A display apparatus is a device for visually displaying information. The display apparatus may be used in computers, mobile devices, televisions, watches, vehicles, and the like. When the display apparatus is used in a vehicle, various types of content such as traveling information of a vehicle, vehicle status, and entertainment may be provided to users. In order to provide more diverse content to the users, a panel of a display apparatus may be manufactured to be larger than a panel of the related art.

The display panel may be provided as a variety of display panels, such as rollable, foldable, and slidable display panels. There is a problem that, when such a display panel is manufactured to be larger than a display panel of the related art, the display panel is highly likely to be damaged due to external shock, vibration, or the like. Accordingly, a display apparatus with a large screen is not manufactured.

Alternatively, even when the display apparatus is installed as a large screen on the rear side in the vehicle, there is a problem that the display apparatus may obstruct a view of the user. For example, a front view of occupants seated on rear seats of the vehicle may be screened. Alternatively, a rear view of occupants seated on front seats of the vehicle may be screened.

### SUMMARY

In view of the above, the present disclosure is intended to solve these problems, and a main object of the present disclosure is to provide various types of content to occupants in a vehicle by installing a display apparatus with a large screen on a rear side in the vehicle, and to prevent a view of the occupants in the vehicle from being obstructed even when the display apparatus with a large screen is installed on the rear side in the vehicle.

Further, another object of the present disclosure is to provide a display apparatus that has a low possibility of damage to a display panel due to external shock or vibration even when a large-screen display apparatus is applied to a vehicle.

Further, another main object of the present disclosure is to facilitate driver intervention even when a large-screen display apparatus is applied to the front side in an autonomous vehicle.

The problems to be solved by the present disclosure are not limited to the problems mentioned above, and other problems not mentioned can be clearly understood by those skilled in the art from the description below

An embodiment of the present disclosure provides a transparent display apparatus disposed inside a vehicle, the transparent display apparatus comprising: a transparent display panel configured to transmit light from a first surface to a second surface; a rotation part coupled to one end of the transparent display panel; an anchoring part fixed to a ceiling of the vehicle, wherein the anchoring part includes a motor coupled to at least a portion of the rotation part and configured to rotate the rotation part about a longitudinal direction of the rotation part; an interface unit mounted inside the transparent display panel and/or the vehicle to receive a user command; and a control unit operatively connected to the interface unit and the motor, and configured to perform control so that the transparent display panel is switched to a plurality of modes based on a user command received from the interface unit.

Another embodiment of the present disclosure provides a roll-up display apparatus, comprising: a panel assembly, wherein the panel assembly includes a display panel formed to be slid, bent, or folded to display a video to a user, and an anchoring part disposed at an end of the display panel and at least partially made of a magnet; and a housing disposed on a dashboard of a vehicle, accommodating the panel assembly, and including a panel control unit electrically connected to the panel assembly to control the panel assembly, wherein the panel assembly is operated by the panel control unit in a first state in which the display panel is rolled and accommodated in the housing, a second state in which the display panel is unrolled toward a ceiling of the vehicle from the housing to screen a portion of a front windshield of the vehicle, and a third state in which the display panel is unrolled toward the ceiling of the vehicle from the housing to screen the entire front windshield.

Another embodiment of the present disclosure provides a roll-down display apparatus, comprising: a panel assembly, wherein the panel assembly includes a display panel formed to be slid, bent, or folded to display a video to a user, and an anchoring part disposed at an end of the display panel and at least partially made of a magnet; and a housing disposed on a ceiling of a vehicle, accommodating the panel assembly, and including a panel control unit electrically connected to the panel assembly to control the panel assembly, wherein the panel assembly is operated by the panel control unit in a first state in which the display panel is rolled and accommodated in the housing, a second state in which the display panel is unrolled toward a dashboard of the vehicle from the housing to screen a portion of a front windshield of the vehicle, and a third state in which the display panel is unrolled toward the dashboard of the vehicle from the housing to screen the entire front windshield.

Another embodiment of the present disclosure provides A control method for a panel control unit of a roll-up or roll-down display apparatus disposed on a front side inside a vehicle, the control method comprising: determining, by the panel control unit, whether the vehicle is in a traveling state; determining, by the panel control unit, whether the display apparatus is in a rolled-in state or a rolled-out state; performing, by the panel control unit, control so that the display apparatus comes to the rolled-out state according to a user selection in response that the vehicle is in the traveling state and the display apparatus is in the rolled-in state; dividing, by the panel control unit, an area of a panel of the display apparatus into a plurality of areas in response that the vehicle is in the traveling state and the display apparatus is in the rolled-out state; determining, by the panel control unit, whether a driver traveling assistance is necessary; and performing, by the panel control unit, control so that the display apparatus is folded in response that the driver traveling assistance is necessary.

Another embodiment of the present disclosure provides A control method for a panel control unit of a roll-up or roll-down display apparatus disposed on a front side inside a vehicle, the control method comprising: determining, by the panel control unit, whether the vehicle is in a traveling state; determining, by the panel control unit, whether the display apparatus is in a rolled-in state or a rolled-out state; performing, by the panel control unit, control so that the display apparatus comes to the rolled-out state according to a user selection in response that the vehicle is in the traveling state and the display apparatus is in the rolled-in state; dividing, by the panel control unit, an area of a panel of the display apparatus into a plurality of areas in response that the vehicle is in the traveling state and the display apparatus is in the rolled-out state; determining, by the panel control unit, whether a driver traveling assistance is necessary; and performing, by the panel control unit, control so that the plurality of areas is integrated into one area and a forward side of the vehicle is displayed in response that the driver traveling assistance is necessary.

As described above, according to the present embodiment, there is an effect that it is possible to provide various types of content to the occupants in the vehicle by installing the display apparatus with a large screen on the rear side in the vehicle, and to prevent the view of the occupants in the vehicle from being obstructed even when the display apparatus with a large screen is installed on the rear side in the vehicle.

Further, according to the present embodiment, there is an effect that it is possible to provide a display apparatus that has a low possibility of damage to a display panel due to external shock or vibration even when a large-screen display apparatus is applied to a vehicle.

Further, according to the present embodiment, there is an effect that it is possible to facilitate driver intervention even when a large-screen display apparatus is applied to the front side in an autonomous vehicle.

### BRIEF DESCRIPTION OF THE DRAWINGS

FIG. 1 is a side view of a vehicle with a large-screen transparent display apparatus according to an embodiment of the present disclosure.

FIGS. 2A to 2E are diagrams illustrating an example in which a large-screen transparent display apparatus operates according to an embodiment of the present disclosure.

FIG. 3 is a diagram illustrating a state in which components of the large-screen transparent display apparatus is electrically connected according to an embodiment of the present disclosure.

FIG. 4 is a diagram illustrating a front of a display apparatus according to another embodiment and yet another embodiment of the present disclosure.

FIG. 5 is a diagram illustrating a rear of the display apparatus according to another embodiment and yet another embodiment of the present disclosure.

FIG. 6 is a diagram illustrating a panel assembly according to another embodiment and yet another embodiment of the present disclosure.

FIGS. 7A to 7C are diagrams illustrating an operating state of a display apparatus according to another embodiment of the present disclosure.

FIGS. 8A to 8C are diagrams illustrating an operating state of a display apparatus according to yet another embodiment of the present disclosure.

FIG. 9 is a flowchart of a first control method for a panel control unit according to the present disclosure.

FIG. 10 is a flowchart of a second control method for a panel control unit according to the present disclosure.

FIG. 11 is a diagram illustrating a case where the panel control unit divides the area of the display panel into a plurality of areas using the first and second control methods according to the present disclosure.

FIG. 12 is a diagram illustrating a case where the panel control unit integrates the plurality of areas of the display panel into one area using the second control method according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components.

When a component is described as being ‘linked,’ ‘coupled,’ or ‘connected’ to another component, it should be understood that the component may be directly linked or connected to the other component, and that yet another component may be ‘linked,’ ‘coupled,’ or ‘connected’ between each component.

Throughout the present specification, when a part ‘includes’ or ‘comprises’ a component, the part is meant to further include other components, not to exclude thereof unless specifically stated to the contrary.

The terms such as ‘unit’, ‘module’, and the like refer to one or more units for processing at least one function or operation, which may be implemented by hardware, software, or a combination thereof.

Unless otherwise noted, the description of one embodiment is intended to be applicable to other embodiments.

The following detailed description, together with the accompanying drawings, is intended to describe exemplary embodiments of the present invention and is not intended to represent the only embodiments in which the present invention may be practiced.

In the present disclosure, the term rolling a display panel refers to winding the display panel. In the present disclosure, the term unrolling the display panel refers to unfolding a portion of the display panel and discharging the portion from a housing.

In the present disclosure, a rolled-in state of a display apparatus is a state in which a display panel is rolled and accommodated in a housing. A rolled-out state of the display apparatus is a state in which the display panel is unrolled and discharged from the housing to the outside.

In this disclosure, the term user is a person who uses a large screen transparent display apparatus according to the present disclosure or a device (for example, artificial intelligence) that uses the large screen transparent display apparatus according to the present disclosure. Accordingly, the term user may include a driver and occupants of the vehicle.

The display apparatus according to the present disclosure may be disposed inside the vehicle. In particular, the display apparatus according to the present disclosure may be configured to display an image or video to occupants on rear seats of the vehicle.

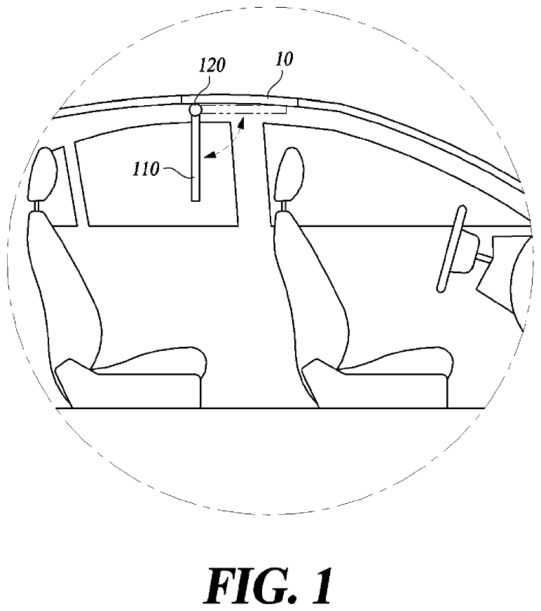

FIG. 1 is a side view of a vehicle with a large-screen transparent display apparatus according to an embodiment of the present disclosure.

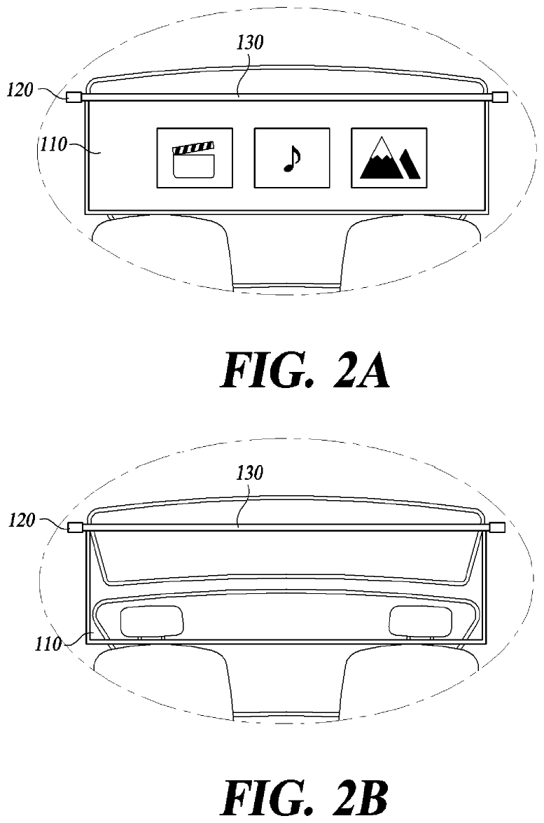

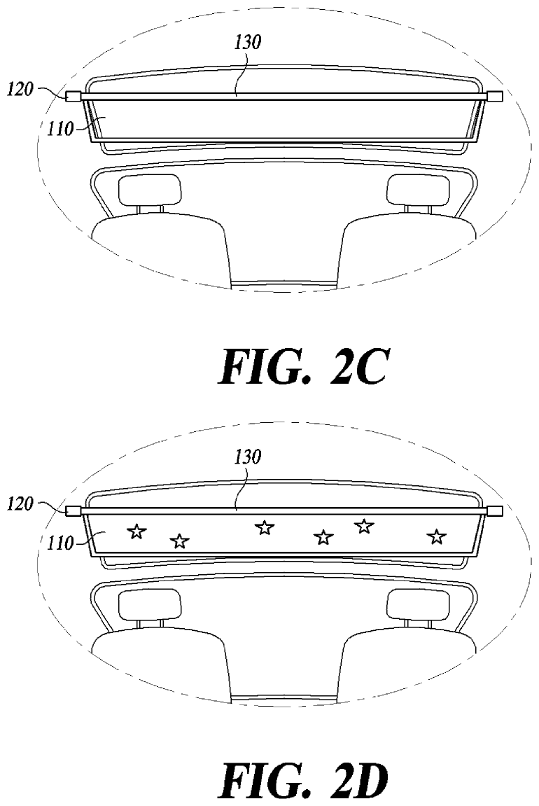

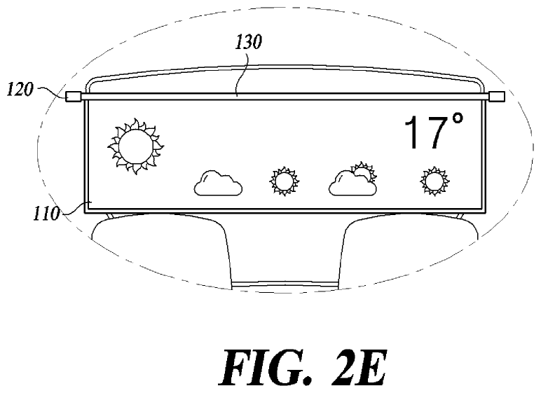

FIGS. 2A to 2E are diagrams illustrating an example in which a large-screen transparent display apparatus operates according to an embodiment of the present disclosure. To be specific, FIG. 2A is a diagram illustrating a state in which the transparent display panel operates in a first mode in a second state. FIG. 2B is a diagram illustrating a state in which the transparent display panel operates in a second mode in a second state. FIG. 2C is a diagram illustrating a state in which the transparent display panel operates in the second mode in the first state. FIG. 2D is a diagram illustrating a state in which the transparent display panel operates in a third mode in the first state. FIG. 2E is a diagram illustrating a state in which the transparent display panel operates in the third mode in the second state.

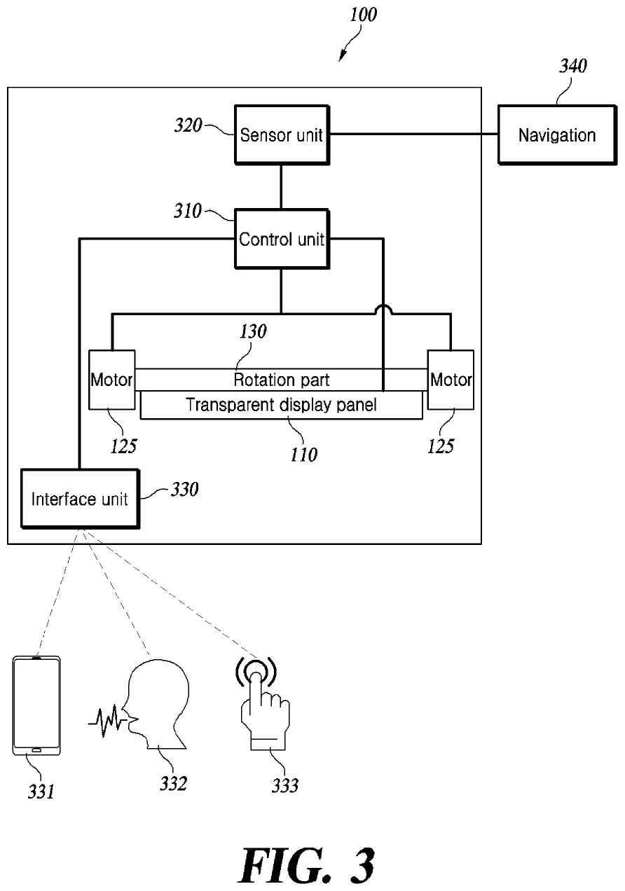

FIG. 3 is a diagram illustrating a state in which components of the large-screen transparent display apparatus is electrically connected according to an embodiment of the present disclosure.

Referring to FIGS. 1 to 3, a transparent display apparatus 100 according to an embodiment of the present disclosure includes a transparent display panel 110, a rotation part 130, an anchoring part 120, an interface unit 330, a control unit 310, and a sensor unit 320.

The transparent display panel 110 may be configured to transmit light from a first surface to a second surface of the transparent display panel 110. Here, the first surface of the transparent display panel 110 is a surface that displays a video or image or a back surface, and the second surface is a surface opposite to the first surface. For example, when the first surface of the transparent display panel 110 is the surface that displays a video or image, the other side is an opposite side. The transparent display panel 110 may be configured as an electronic or optical type.

When the transparent display panel 110 is configured electronically, the transparent display panel 110 may be operated by a light emitting diode (LED) elements included inside the transparent display panel 110 directly emitting light. In order for the transparent display panel 110 to be configured electronically, components of the transparent display panel 110 may be made of a transparent material. For example, indium tin oxide (ITO) may be used for electrodes of the transparent display panel 110. An organic light emitting diode (OLED) may be used as a discharge material for the transparent display panel 110. However, the components of the transparent display panel 110 are not limited to the materials described above.

When the transparent display panel 110 is configured optically, the transparent display panel 110 may be configured using optical characteristics such as reflection or refraction. Therefore, the transparent display panel 110 may be made of a material such as a reflector or optical film.

The transparent display panel 110 may be disposed so that a user seated on a rear seat of the vehicle can view a video or image displayed on the transparent display panel 110. For example, as can be seen in FIG. 1, the transparent display panel 110 may be disposed on a rear surface portion of a front seat of the vehicle. The transparent display panel 110 may be disposed to screen a glass sunroof 10 of the vehicle by rotating together with the rotation part 130, which will be described below, about a longitudinal direction of the rotation part 130 which will be described below.

As can be seen in FIGS. 2A to 2E, the transparent display panel 110 may include a bezel. However, the transparent display panel 110 may not include a bezel, unlike that illustrated in the drawing.

The rotation part 130 may be coupled to one end of the transparent display panel 110. Here, the end of the transparent display panel 110 refers to an upper corner of the transparent display panel 110 when the transparent display panel 110 is disposed in a vehicle. The rotation part 130 may be a long cylindrical bar. However, the rotation part 130 may be a long rectangular bar, unlike that described above. The rotation part 130 may be made of a transparent material. For example, the rotation part 130 may be made of glass, plastic, acrylic, polycarbonate, crystal, or the like. The rotation part 130 may be disposed perpendicularly to a longitudinal direction of the vehicle on a ceiling of the vehicle.

The anchoring part 120 may be fixed to the ceiling of the vehicle. The anchoring part 120 may be coupled to at least a portion of the rotation part 130 and configured to be made so that the rotation part 130 is fixed to the ceiling of the vehicle. The anchoring part 120 may include a motor 125 configured to rotate the rotation part 130 about the longitudinal direction of the rotation part 130.

The interface unit 330 may be mounted inside the transparent display panel 110. Alternatively, the interface unit 330 may be mounted outside the transparent display panel 110 or inside the vehicle. For example, the interface unit 330 may be built in the form of a button on an armrest disposed inside a vehicle. The interface unit 330 may be configured to receive user commands. As can be seen in FIG. 3, the interface unit 330 is configured to receive user commands by interworking 331 with an application of a mobile terminal using wireless communication. Here, the wireless communication may be operated in various ways, such as Bluetooth, Wireless Fidelity (WIFI), data communication, and Near Field Communication (NFC). Alternatively, the interface unit 330 may be configured to receive user commands by using a scheme 332 for recognizing user's voice using a speech recognition sensor. Alternatively, the interface unit 330 may be configured to receive user commands from a user touch 333 by being configured of an area allowing the transparent display panel 110 to be touched. However, the interface unit 330 is not limited to receiving the user commands using the above-described schemes.

The control unit 310 may be electrically connected to the interface unit 330. The control unit 310 may perform control so that a state of the transparent display panel 110 is changed based on a user command received from the interface unit 330 or an algorithm in the control unit 310. The state of the transparent display panel 110 may include a first state and a second state. The first state is a state in which the transparent display panel 110 is disposed substantially parallel to the ceiling of the vehicle by driving the motor 125 to rotate the rotation part 130. The second state refers to a state in which the transparent display panel 110 is disposed approximately perpendicular to the ceiling of the vehicle by driving the motor 125 to rotate the rotation part 130. Here, it should be noted that the terms parallel and perpendicular are used for convenience of description, and do not mean that parallel and perpendicular are mathematically completely parallel or perpendicular. When the transparent display panel 110 is in the second state and the vehicle stalls, the control unit 310 may perform control so that the transparent display panel 110 comes to the first state. Alternatively, when the transparent display panel 110 is in the first state and the vehicle starts up, the control unit 310 may perform control so that the transparent display panel 110 comes to the second state.

The control unit 310 may perform control so that the transparent display panel 110 is switched to a plurality of modes based on a user command received from the interface unit 330 or an algorithm built into the control unit 310. The plurality of modes may include a first mode, a second mode, and a third mode. The first mode is a mode in which the transparent display panel 110 displays a video or an image, as can be seen in FIG. 2A. The second mode is a mode in which the transparent display panel 110 maintains a transparent state, as can be seen in FIG. 2C. The third mode is a mode in which the transparent display panel 110 displays a video or image generated based on a vehicle environment, as can be seen in FIGS. 2D and 2E. As can be seen in FIGS. 2B, when the transparent display panel 110 is in the first mode or the third mode in the second state, the control unit 310 may perform control so that the transparent display panel 110 comes to the transparent state when the vehicle is in a backward traveling state.

The sensor unit 320 may be electrically connected to the control unit 310. The sensor unit 320 may include a temperature sensor, a humidity sensor, and a photoresistor. The sensor unit 320 may receive weather and time information by being electrically connected to a navigation system 340 mounted on the vehicle or connected to the navigation system 340 using wireless communication.

The first mode may include an environmental information mode using the sensor unit 320. The environmental information mode is a mode in which the transparent display panel 110 displays a video or image in the first mode and information received from the sensor unit 320 is displayed on at least a portion of the transparent display panel 110. For example, when the transparent display panel 110 is in the environmental information mode, a temperature inside and outside the vehicle, today's weather, and fine dust information received from the sensor unit 320 may be displayed at a left lower end of the transparent display panel 110.

The third mode may include an automatic environment mode in which the sensor unit 320 is used. The automatic environment mode refers to a mode in which an image is displayed on the transparent display panel 110 based on information received from the sensor unit 320. An image display method in the automatic environment mode is as follows. One of a plurality of images in the control unit 310 is automatically selected. The selected image is generated based on information received from the sensor unit 320. The generated image is displayed on the transparent display panel 110. For example, when a current time is around evening and the transparent display panel 110 is in the automatic environment mode, an image of stars floating in the sky may be displayed based on current position information of the vehicle. Stars in the displayed image may match actual constellation information. Alternatively, the automatic environment mode may be configured so that the transparent display panel 110 displays an image that gives a warm or cool feeling based on current temperature information.

Hereinafter, effects of the large-screen transparent display apparatus 100 according to the present disclosure will be described in detail.

The display apparatus is required to have a display panel with a large screen in order to provide various types of content to users. In particular, when the display apparatus is disposed at the rear side in the vehicle for occupants seated on rear seats of the vehicle, the display panel may be required to be larger compared to a display panel of the related art. However, there is a problem in that, when the display apparatus disposed in the rear side in the vehicle is larger, a degree of obstructed view of the vehicle occupants is higher. In order to solve this problem, the transparent display apparatus 100 according to the present disclosure is configured with the transparent display panel 110. The transparent display apparatus 100 according to the present disclosure may make the display panel transparent according to a user's need. For example, when the vehicle is in the backward traveling state, a video displayed on the transparent display panel may be automatically stopped and the transparent display panel 110 may be made transparent according to an algorithm of the control unit. With the transparent display apparatus 100 according to the present disclosure, it is possible to minimize an obstructed view of a driver so that traveling of the vehicle is not obstructed even when the transparent display apparatus 100 is disposed as a large-screen display apparatus on the rear side in the vehicle.

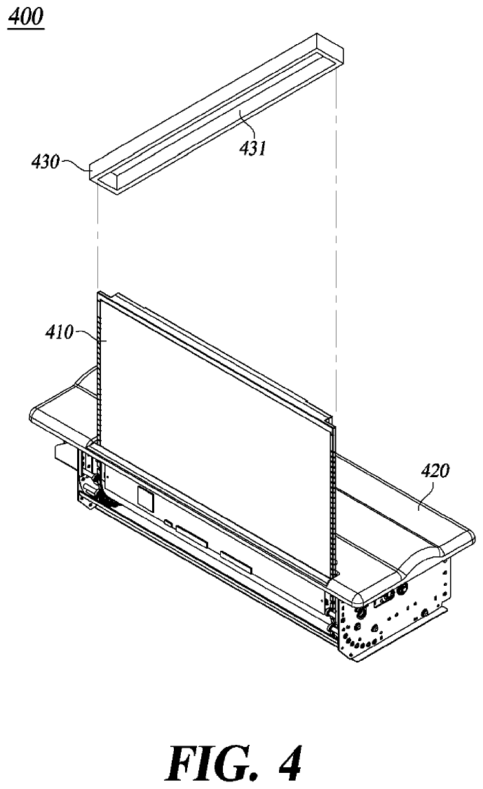

FIG. 4 is a diagram illustrating a front of a display apparatus according to another embodiment and yet another embodiment of the present disclosure.

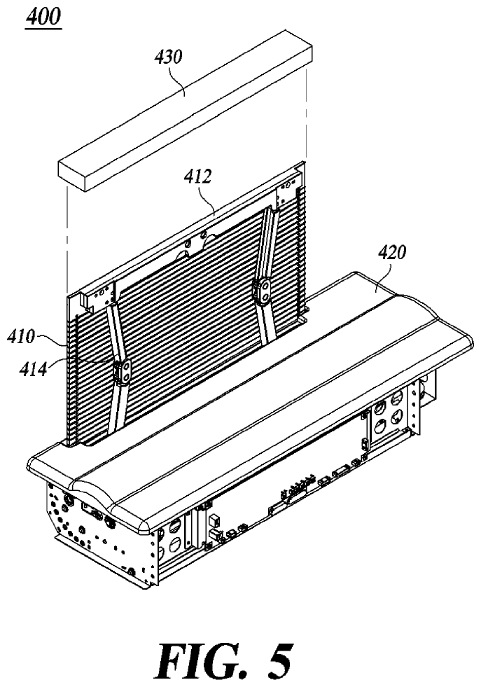

FIG. 5 is a diagram illustrating a rear of the display apparatus according to another embodiment and yet another embodiment of the present disclosure.

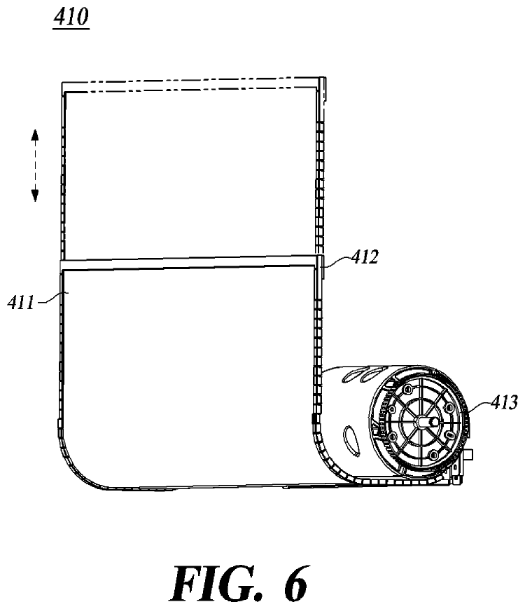

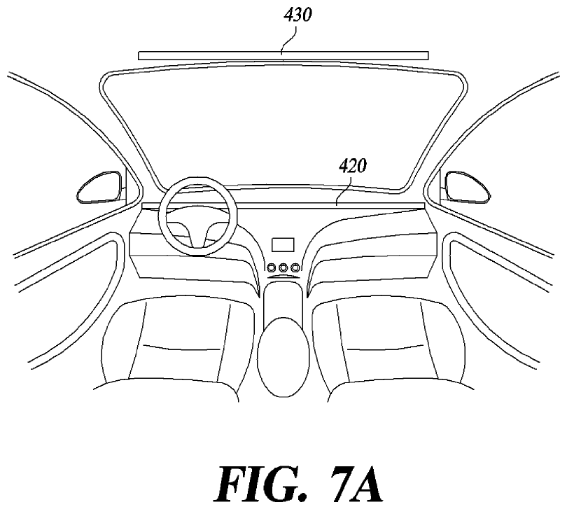

FIG. 6 is a diagram illustrating a panel assembly according to another embodiment and yet another embodiment of the present disclosure.

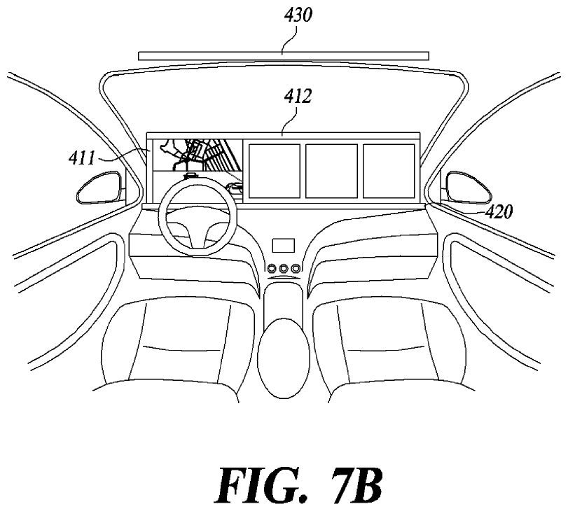

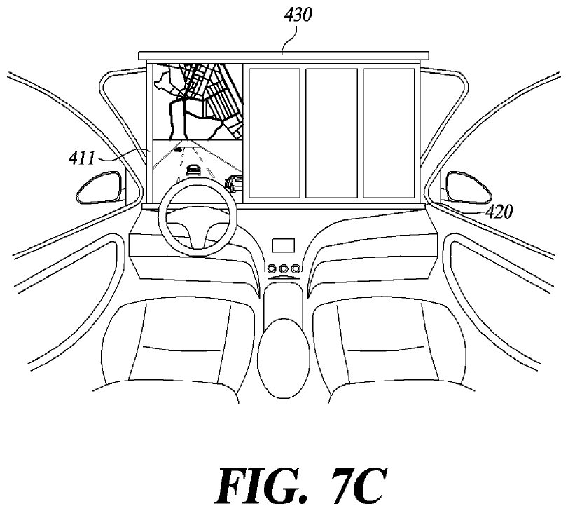

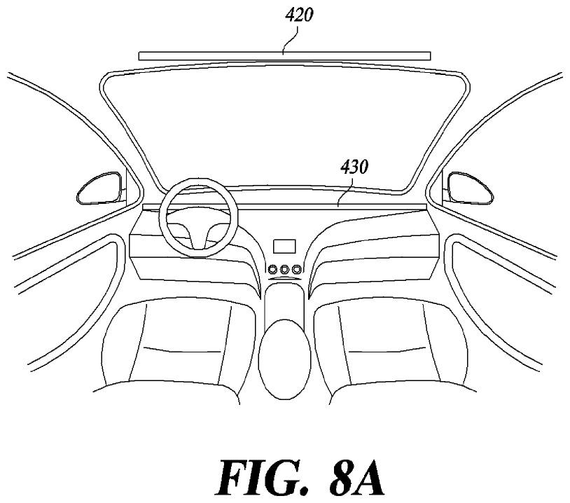

FIGS. 7A to 7C are diagrams illustrating an operating state of a display apparatus according to another embodiment of the present disclosure. To be specific, FIG. 7A is a diagram in which operating state in which the display apparatus operates in the first state according to another embodiment of the present disclosure. FIG. 7B is a diagram illustrating an operating state in which the display apparatus operates in the second state according to another embodiment of the present disclosure. FIG. 7C is a diagram illustrating an operating state in which the display apparatus operates in a third state according to another embodiment of the present disclosure.

Referring to FIGS. 4 to 7C, a display apparatus 400 according to another embodiment of the present disclosure includes all or some of a panel assembly 410, a housing 420, and a panel guide 430. The display apparatus 400 according to another embodiment of the present disclosure may be a roll-up type display apparatus 400. Here, the roll-up type display apparatus refers to a display apparatus in which a display panel is unrolled from bottom to top in a vertical direction, which is a direction of gravity of the Earth, with an axis in the vertical direction as a reference.

The panel assembly 410 may be accommodated in the housing 420, which will be described below. The panel assembly 410 may include all or some of a display panel 411, an anchoring part 412, a rotation part 413, and a supporter 114.

The display panel 411 may display a screen to the user. The display panel 411 may display screens for information on the vehicle, a forward side of the vehicle, and entertainment. A width of the display panel 411 may be the same as a width of a dashboard inside the vehicle. Here, the width of the display panel 411 and the dashboard is length in a direction between both side mirrors of the vehicle. The dashboard inside the vehicle may include a cockpit of the vehicle. The display panel 411 may include several components for displaying a screen. The display panel 411 may be configured to slid, bent, or folded. For example, the display panel 411 may be a flexible display panel such as a rollable display panel, a foldable display panel, and a slidable display panel. However, the display panel 411 is not limited to the display panel described above.

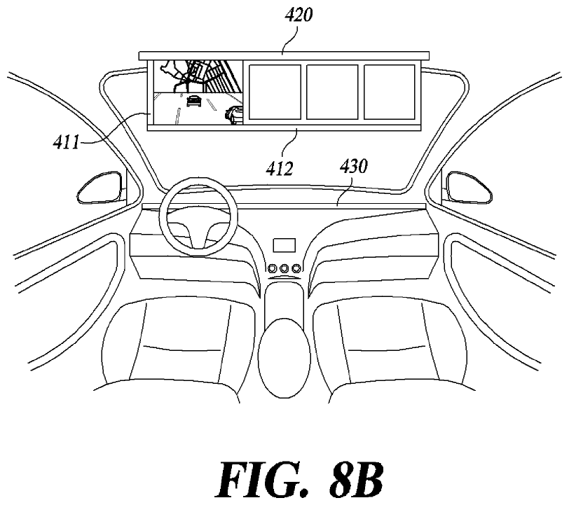

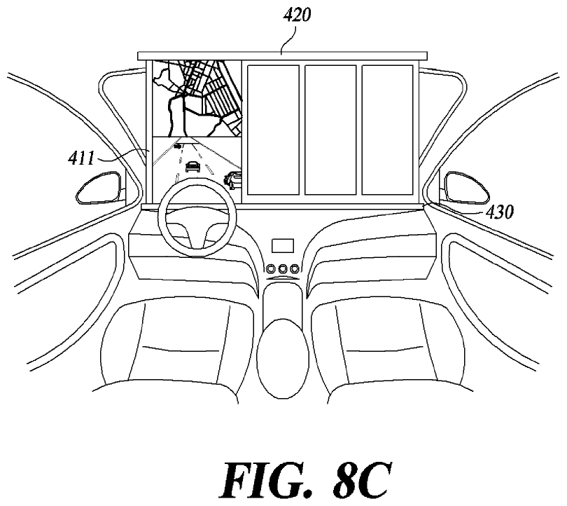

The anchoring part 412 may be disposed at an end of the display panel 411. Here, the end of the display panel is a part that is discharged first from the housing 420, which will be described below, when the display panel 411 is unrolled. That is, as can be seen in FIG. 8B, the anchoring part 412 may be disposed at the end of the display panel 411 in a direction of the ceiling of the vehicle. However, alternatively, the anchoring part 412 may be disposed in a middle portion of a rear surface of the display panel 411. That is, the anchoring part 412 may be configured to prevent the display panel 411 from being damaged by external vibration or impact by fixing the unrolled display panel 411. Here, a magnet may be a permanent magnet such as Alnico, Neodymium Iron Boron (NdFeB), Ceramic (Ferrite), Samarium Cobalt (SmCo), or a flexible magnet. Alternatively, the magnet may be an electronic magnet such as a solenoid, electromagnetic bar, or toroid. The anchoring part 412 may be coupled and fixed to a panel mounting area 431 of the panel guide 430, which will be described below. For example, when at least a portion of the anchoring part 412 is made of a magnet, the anchoring part 412 may be coupled to the panel mounting area 431 using magnetic force.

When necessary, the display panel may be manufactured to be thinner and wider than that in the related art. When the display panel is manufactured to be thin and wide, the display panel may become vulnerable to external vibration and shock. When the display panel is a rollable, foldable, or slidable display panel, a bezel may be omitted. When the bezel is omitted, the display panel may be more vulnerable to external vibration and shock compared to a case in which there is the bezel.

In order to solve the above-described problem, the end of the unrolled display panel 411 is fixed in the display apparatus 400 according to another embodiment of the present disclosure. When the end of the unrolled display panel 411 is fixed, the display panel 411 may be protected from external vibration and shock. In this case, even when the end of the display panel 411 moves away from the housing 420, which will be described below, the end of the display panel 411 can be protected from external shock, or the like.

The rotation part 413 may serve to provide power when the display panel 411 is rolled or unrolled. As can be seen in FIG. 6, a diameter of an outer circumference of the rotation part 413 may be the same as a diameter of an inner circumference of the display panel 411 in the rolled state. The rotation part 413 may be configured to rotate using a motor. When the rotation part 413 rotates, the display panel 411 may be rolled or unrolled. For example, when the rotation part 413 rotates clockwise in FIG. 6, the display panel 411 may be unrolled and come to the rolled-out state. On the other hand, when the rotation part 413 rotates counterclockwise, the display panel 411 may be rolled and come to the rolled-in state.

The supporter 114 may guide a rolling or unrolling direction of the display panel 411 when the display panel 411 is rolled or unrolled. The supporter 114 may serve to support the display panel 411 in an unrolled state.

The panel assembly 410 may operate in the first state, the second state, and the third state. In the display apparatus 400 according to another embodiment of the present disclosure, the first state is a state in which the display panel 411 is rolled and accommodated in the housing 420 to be described below, as can be seen in FIG. 7A. The second state is a state in which the display panel 411 is unrolled toward the ceiling of the vehicle from the housing 420, which will be described below, to screen a portion of the windshield of the vehicle, as can be seen in FIG. 7B. The third state is a state in which the display panel 411 is unrolled toward the ceiling of the vehicle from the housing 420, which will be described below to screen most of the windshield of the vehicle, as can be seen in FIG. 7C. The panel assembly 410 may be switched to each state by a panel control unit, which will be described below, or by a user selection. The second state is not limited to that illustrated in FIG. 7B and may include a state in which a portion of the windshield of the vehicle is screened.

In autonomous vehicles, there are restrictions on a size of a display panel for driver intervention. That is, a display panel of the related art is manufactured with such a size that a front view of the driver is ensured. The display apparatus 400 according to another embodiment of the present disclosure may include a panel assembly 410 in a third state in which the front view of the driver is completely screened. The display apparatus 400 according to another embodiment of the present disclosure may be configured to allow driver intervention even when the entire front view of the driver is screened by switching the panel assembly 410 to the first, second, or third state. Such a display apparatus 400 may provide various types of content such as vehicle traveling information and entertainment to the user even while the vehicle is traveling.

The housing 420 may be disposed on a dashboard of the vehicle. The housing 420 may accommodate the panel assembly 410. The housing 420 may include a panel control unit that is electrically connected to the panel assembly 410 to control the panel assembly 410. The housing 420 may be inserted into or disposed on the dashboard inside the vehicle. Alternatively, the housing 420 may be configured to be integrated with the dashboard inside the vehicle.

The panel guide 430 may be disposed in an upper portion in the vehicle. As can be seen in FIGS. 7A to 7C, the upper portion in the vehicle is the ceiling of the vehicle or a vicinity thereof. The panel guide 430 may be coupled to the anchoring part 412. The panel guide 430 may accommodate at least a portion of the anchoring part 412. The panel guide 430 may include the panel mounting area 431 disposed at a lower end of the panel guide 430.

The panel mounting area 431 may be made of magnets. Here, the magnet may be the same type of magnet as that of the above-described anchoring part 412. Alternatively, the panel mounting area 431 and the anchoring part 412 may be different types of magnets. For example, the anchoring part 412 may be a permanent magnet, and the panel mounting area 431 may be an electromagnet. The panel mounting area 431 may be configured in the form of a slit to accommodate at least a portion of the anchoring part 412.

FIGS. 8A to 8C are diagrams illustrating an operating state of a display apparatus according to yet another embodiment of the present disclosure. To be specific, FIG. 8A is a diagram in which operating state in which the display apparatus operates in the first state according to another embodiment of the present disclosure. FIG. 8B is a diagram in which operating state in which the display apparatus operates in the second state according to another embodiment of the present disclosure. FIG. 8C is a diagram in which operating state in which a display apparatus operates in the third state according to another embodiment of the present disclosure.

Referring to FIGS. 4 to 6 and 8A to 8C, the display apparatus 400 according to another embodiment of the present disclosure may include all or some of the panel assembly 410, the housing 420, and the panel guide 430. The display apparatus 400 according to another embodiment of the present disclosure may be a roll-down type display apparatus 400. Here, the roll-down type display apparatus is a display apparatus in which the display panel is unrolled from top to bottom in a vertical direction with an axis in the vertical direction as a reference.

Since configurations and effects may be the same as those of other embodiments of the present disclosure except for content particularly described below in another embodiment of the present disclosure, detailed description thereof will be omitted.

The panel assembly 410 may operate in the first state, the second state, and the third state. In the display apparatus 400 according to another embodiment of the present disclosure, the first state is a state in which the display panel 411 is rolled and accommodated in the housing 420, as can be seen in FIG. 8A. The second state is a state in which the display panel 411 is unrolled toward the dashboard of the vehicle from the housing 420 to cover a portion of the windshield of the vehicle, as can be seen in FIG. 8C. The third state is a state in which the display panel 411 is unrolled toward the dashboard of the vehicle from the housing 420 to screen the entire windshield of the vehicle, as can be seen in FIG. 8C. The panel assembly 410 may be switched to each state by a panel control unit, which will be described below, or by a user selection. The second state is not limited to that illustrated in FIG. 8B and may include a state in which a portion of the windshield of the vehicle is screened.

The housing 420 may be disposed on the ceiling of the vehicle. Accordingly, the panel guide 430 may be disposed on the dashboard of the vehicle. The panel guide 430 may include a panel mounting area 431 disposed at an upper end of the panel guide 430.

The roll-down type display apparatus may be less affected by gravity as compared to a roll-up type display apparatus when the display panel is unrolled. With this type of display apparatus, it is possible to maximize space utilization of the vehicle because the display panel is rolled and accommodated in the housing disposed on the ceiling of the vehicle.

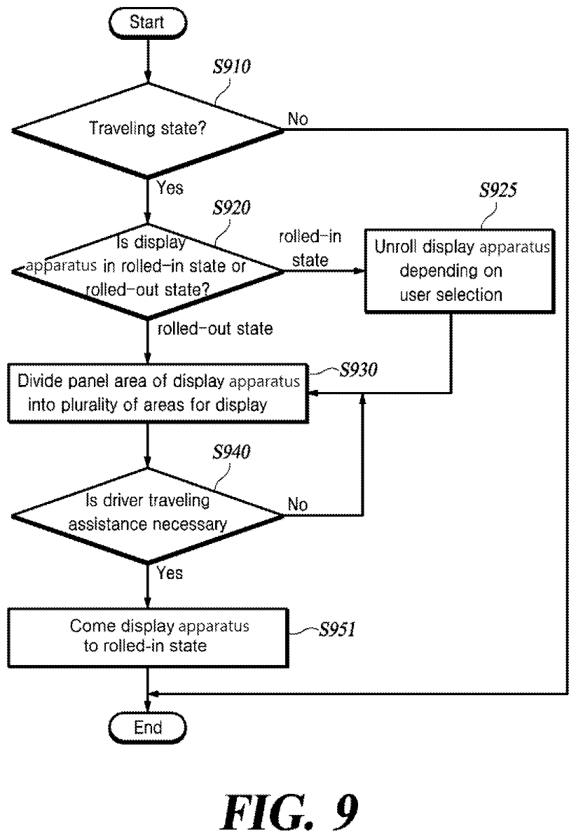

FIG. 9 is a flowchart of a first control method for a panel control unit according to the present disclosure.

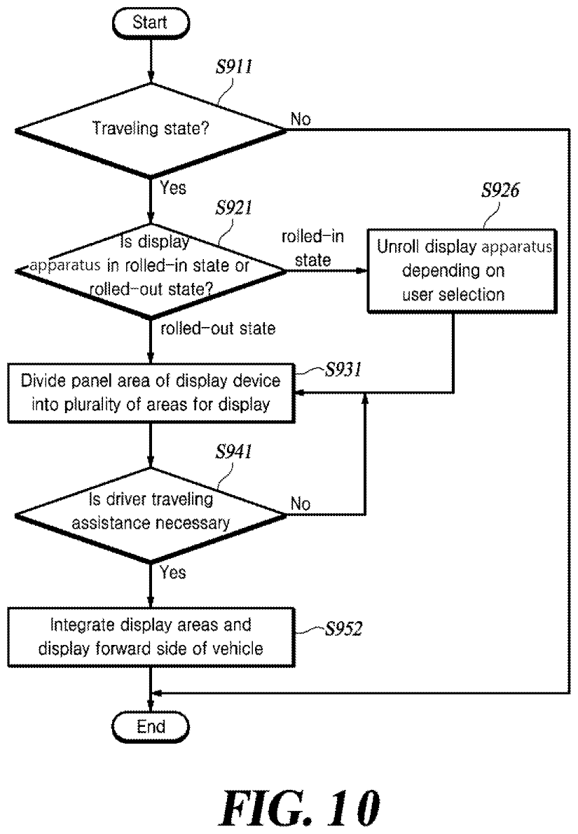

FIG. 10 is a flowchart of a second control method for a panel control unit according to the present disclosure.

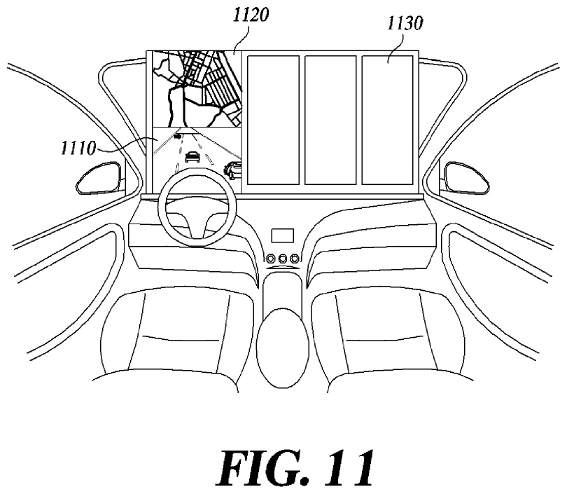

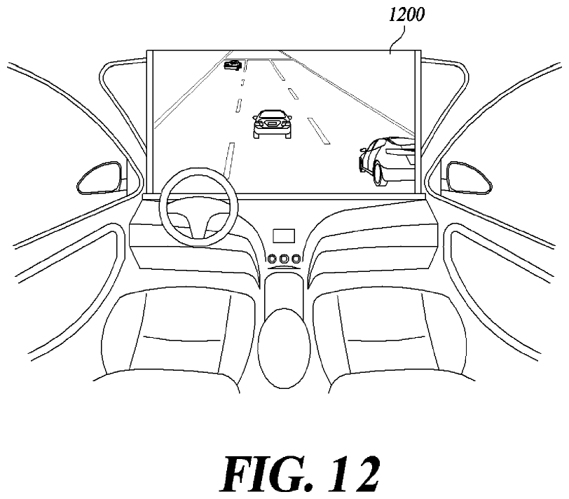

FIG. 11 is a diagram illustrating a case where the panel control unit divides the area of the display panel into a plurality of areas using the first and second control methods according to the present disclosure.

FIG. 12 is a diagram illustrating a case where the panel control unit integrates the plurality of areas of the display panel into one area using the second control method according to the present disclosure.

Hereinafter, the first control method of the panel control unit according to the present disclosure will be described and then the second control method will be described with reference to FIGS. 9 to 12. Here, it should be noted that first and second for distinguishing between the embodiments and first and second for distinguishing between the control methods are not related to each other.

The roll-up or roll-down type display apparatus 400 according to the first or other embodiment of the present disclosure may include a panel control unit.

Hereinafter, the first control method of the panel control unit according to the present disclosure will be described.

The panel control unit may determine whether the vehicle is in the traveling state (S910). When the vehicle is in the traveling state, the panel control unit may determine whether the display apparatus 400 is in a rolled-in state or a rolled-out state (S920). On the other hand, when the vehicle is not in a traveling state, the algorithm ends. When the vehicle is in the traveling state and the display apparatus 400 is in a rolled-in state, the panel control unit may perform control so that the display apparatus 400 comes to the rolled-out state depending on a user selection (S925). When the vehicle is in the traveling state and the display apparatus 400 is in the rolled-out state, the panel control unit may divide an area of the panel of the display apparatus 400 into a plurality of areas (S930). The plurality of areas may be a first area 1110, a second area 1120, and a third area 1130. The first area 1110 is an area for displaying a forward side of the vehicle. The second area 1120 is an area for providing traveling information of the vehicle. The third area 1130 is an area other than the first area 1110 and the second area 1120. The panel control unit may determine whether or not the driver traveling assistance is necessary (S940). When the driver traveling assistance is necessary, the panel control unit may perform control so that the display apparatus 400 comes to the rolled-in state (S951). Here, a case in which the driver traveling assistance is necessary includes sudden weather change, appearance of construction zones or road obstacles, sudden stop or sudden acceleration of the vehicle, an abrupt change in driving environment, a user emergency state, or the like.

Hereinafter, the second control method for the panel control unit according to the present disclosure will be described.

The panel control unit may determine whether the vehicle is in the traveling state (S911). When the vehicle is in the traveling state, the panel control unit may determine whether the display apparatus 400 is in the rolled-in state or the rolled-out state (S921). On the other hand, when the vehicle is not in the traveling state, the algorithm ends. When the vehicle is in the traveling state and the display apparatus 400 is in the rolled-in state, the panel control unit may perform control so that the display apparatus 400 comes to the rolled-out state depending on a user selection (S926). When the vehicle is in the traveling state and the display apparatus 400 is in the rolled-out state, the panel control unit may divide the area of the panel of the display apparatus 400 into the plurality of areas (S931). The plurality of areas may be the first area 1110, the second area 1120, and the third area 1130. The first area 1110 is an area for displaying a forward side of the vehicle. The second area 1120 is an area for providing traveling information of the vehicle. The third area 1130 is an area other than the first area 1110 and the second area 1120. The panel control unit may determine whether or not the driver traveling assistance is necessary (S941). When the driver traveling assistance is necessary, the panel control unit may perform control so that the forward side of the vehicle is displayed by integrating the plurality of areas into one area 1200 (S952).

The panel control unit according to the present disclosure can simultaneously provide traveling information of the vehicle and entertainment to the user by dividing the display panel 411 into a plurality of areas while the vehicle is traveling. The panel control unit according to the present disclosure may be applied to autonomous vehicles with level 3 and level 4. In the case of the autonomous vehicles with level 3 and level 4, driver intervention may be required. Accordingly, the panel control unit according to the present disclosure controls the display apparatus so that the driver may appropriately intervene according to a user, a vehicle status, or vehicle traveling status.

The flowchart of the present disclosure describes processes as being sequentially executed, but this is merely illustrative of the technical idea of an embodiment of the present disclosure. In other words, since it is apparent to those having ordinary skill in the art that an order described in the flowchart may be changed or one or more processes may be executed in parallel without departing from the essential characteristics of an embodiment of the present disclosure, the flowchart is not limited to a time-series order.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device, and may further include a transitory medium such as a data transmission medium. In addition, the computer-readable recording medium may be distributed in a computer system connected via a network, so that computer-readable codes may be stored and executed in a distributed manner.

Various implementations of systems and techniques described herein may be embodied by a programmable computer. Here, the computer includes a programmable processor, a data storage system (including volatile memory, non-volatile memory, or other types of storage systems, or combinations thereof) and at least one communication interface. For example, the programmable computer may be one of a server, a network device, a set top box, an embedded device, a computer expansion module, a personal computer, a laptop, a personal data assistant (PDA), a cloud computing system, or a mobile device.

Although exemplary embodiments of the present disclosure have been described for illustrative purposes, those having ordinary skill in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A transparent display apparatus disposed inside a vehicle, the transparent display apparatus comprising:
a transparent display panel configured to transmit light from a first surface to a second surface;
a rotation part coupled to one end of the transparent display panel;
an anchoring part fixed to a ceiling of the vehicle, wherein the anchoring part includes a motor coupled to at least a portion of the rotation part and configured to rotate the rotation part about a longitudinal direction of the rotation part;
an interface unit mounted inside the transparent display panel and/or the vehicle to receive a user command; and
a control unit operatively connected to the interface unit and the motor, and configured to perform control so that the transparent display panel is switched to a plurality of modes based on a user command received from the interface unit.

2. The transparent display apparatus of claim 1, wherein the interface unit is configured to interwork with an application of a mobile terminal using wireless communication and to receive the user command from the application.

3. The transparent display apparatus of claim 1, wherein the interface unit has a speech recognition function and is configured to receive a user command using the speech recognition function.

4. The transparent display apparatus of claim 1, wherein the control unit performs control so that the transparent display panel comes to a first state in which the transparent display panel is disposed parallel to the ceiling of the vehicle or a second state in which the transparent display panel is disposed perpendicular to the ceiling of the vehicle, by driving the motor to rotate the rotation part.

5. The transparent display apparatus of claim 4, wherein the control unit performs control so that the transparent display panel comes to the first state in response that the transparent display panel is in the second state in a case where the vehicle stalls.

6. The transparent display apparatus of claim 4, wherein the plurality of modes includes:
a first mode in which the transparent display panel displays a video or image;
a second mode in which the transparent display panel maintains a transparent state; and
a third mode in which the transparent display panel displays the video or the image generated based on an environment of the vehicle.

7. The transparent display apparatus of claim 6, wherein the control unit performs control so that the transparent display panel comes to the transparent state, in response that the transparent display panel satisfies all of following conditions:
the transparent display panel is in the second state and in either the first mode or the second mode, and
the vehicle is in a backward traveling state.

8. The transparent display apparatus of claim 6, further comprising:
a sensor unit electrically connected to the control unit,
wherein the sensor unit includes a temperature sensor, a humidity sensor, and an illumination sensor, and
wherein the sensor unit is configured to receive weather and time information from a navigation system mounted on the vehicle.

9. The transparent display apparatus of claim 8, wherein the first mode includes an environmental information mode in which information received from the sensor unit is displayed on at least a portion of the transparent display panel while the video or the image is displayed on the transparent display panel.

10. The transparent display apparatus of claim 8, wherein the third mode includes an automatic environment mode in which the video or the image is generated based on an information received from the sensor unit and the generated video or image is displayed on the transparent display panel.

11. A roll-up display apparatus, comprising:
a panel assembly, wherein the panel assembly includes a display panel formed to be slid, bent, or folded to display a video to a user, and an anchoring part disposed at an end of the display panel and at least partially made of a magnet; and
a housing disposed on a dashboard of a vehicle, accommodating the panel assembly, and including a panel control unit electrically connected to the panel assembly to control the panel assembly,
wherein the panel assembly is operated by the panel control unit in a first state in which the display panel is rolled and accommodated in the housing, a second state in which the display panel is unrolled toward a ceiling of the vehicle from the housing to screen a portion of a front windshield of the vehicle, and a third state in which the display panel is unrolled toward the ceiling of the vehicle from the housing to screen the entire front windshield.

12. The display apparatus of claim 11, further comprising:
a panel guide disposed on an upper portion of the vehicle and coupled to an end of the panel assembly in response that the panel assembly is in the third state.

13. The display apparatus of claim 12, wherein the panel guide includes a panel mounting area disposed at a lower end of the panel guide and made of a magnet.

14. A roll-down display apparatus, comprising:
a panel assembly, wherein the panel assembly includes a display panel formed to be slid, bent, or folded to display a video to a user, and an anchoring part disposed at an end of the display panel and at least partially made of a magnet; and
a housing disposed on a ceiling of a vehicle, accommodating the panel assembly, and including a panel control unit electrically connected to the panel assembly to control the panel assembly,
wherein the panel assembly is operated by the panel control unit in a first state in which the display panel is rolled and accommodated in the housing, a second state in which the display panel is unrolled toward a dashboard of the vehicle from the housing to screen a portion of a front windshield of the vehicle, and a third state in which the display panel is unrolled toward the dashboard of the vehicle from the housing to screen the entire front windshield.

15. The display apparatus of claim 14, further comprising:
a panel guide disposed on the dashboard of the vehicle and coupled to an end of the panel assembly in response that the panel assembly is in the third state.

16. The display apparatus of claim 15, wherein the panel guide includes a panel mounting area disposed at an upper end of the panel guide and made of a magnet.

17. A control method for a panel control unit of a roll-up or roll-down display apparatus disposed on a front side inside a vehicle, the control method comprising:
determining, by the panel control unit, whether the vehicle is in a traveling state;
determining, by the panel control unit, whether the display apparatus is in a rolled-in state or a rolled-out state;
performing, by the panel control unit, control so that the display apparatus comes to the rolled-out state according to a user selection in response that the vehicle is in the traveling state and the display apparatus is in the rolled-in state;
dividing, by the panel control unit, an area of a panel of the display apparatus into a plurality of areas in response that the vehicle is in the traveling state and the display apparatus is in the rolled-out state;
determining, by the panel control unit, whether a driver traveling assistance is necessary; and
performing, by the panel control unit, control so that the display apparatus is folded in response that the driver traveling assistance is necessary.

18. The control method of claim 17, wherein the plurality of areas includes a first area in which a forward side of the vehicle is displayed, a second area in which traveling information of the vehicle is provided, and a third area other than the first area and the second area.

19. A control method for a panel control unit of a roll-up or roll-down display apparatus disposed on a front side inside a vehicle, the control method comprising:
determining, by the panel control unit, whether the vehicle is in a traveling state;
determining, by the panel control unit, whether the display apparatus is in a rolled-in state or a rolled-out state;
performing, by the panel control unit, control so that the display apparatus comes to the rolled-out state according to a user selection in response that the vehicle is in the traveling state and the display apparatus is in the rolled-in state;
dividing, by the panel control unit, an area of a panel of the display apparatus into a plurality of areas in response that the vehicle is in the traveling state and the display apparatus is in the rolled-out state;
determining, by the panel control unit, whether a driver traveling assistance is necessary; and
performing, by the panel control unit, control so that the plurality of areas is integrated into one area and a forward side of the vehicle is displayed in response that the driver traveling assistance is necessary.

20. The control method of claim 19, wherein the plurality of areas includes a first area in which the forward side of the vehicle is displayed, a second area in which traveling information of the vehicle is provided, and a third area other than the first area and the second area.
